(19) United States
(12) Patent Application Publication
(10) Pub. No.: US 2008/0031702 A1
(43) Pub. Date: Feb. 7, 2008

(54) Fast nail plug

(76) Inventors: Ken-Ching Chen, Kaohsiung Hsien (TW); Ting-Tsai Huang, Kaohsiung Hsien (TW); Chun-Chiang Wang, Kaohsiung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/496,462

(22) Filed: Aug. 1, 2006

(51) Int. Cl. F16B 37/04

(52) U.S. Cl. 411/182

(57) ABSTRACT

A fast nail plug includes an outer sleeve and an inner sleeve. The outer sleeve is a cylinder having a through hole and comprises axial slots extending from one end of the outer sleeve toward its middle section to provide flexibility and a plurality of ribs externally disposed on the outer sleeve. The inner sleeve is a cylinder having a through hole and comprises a first end and a second end respectively provided with a locking wall and a retaining wall. The outer diameter of each of the locking wall and the retaining wall is larger than the inner diameter of the through hole of the outer sleeve. The locking wall is flexible by extending from the first end axial slots towards its middle section of the inner sleeve, and a beveled guide surface is provided on the locking wall to penetrate in and lock up the outer sleeve by the locking wall and the retaining wall.

### BACKGROUND OF THE INVENTION

(a) Field of the Invention

The present invention relates to a fast nail plug, and more particularly to one having an inner sleeve and an outer sleeve for site installation or direct installation before the site work.

(b) Description of the Prior Art

U.S. Pat. Nos. 4,085,481; 4,188,685; 4,862,556; 4,982,476; 5,246,322; 5,468,109; 5,561,888; 5,586,364; 5,607,271; 5,626,450; 5,669,108; 5,725,342 and 5,966,779 disclose fast means to fasten bolts, screws or nail plugs into a piece of furniture. All the prior arts cited as above highlight direct mounting of a screw into a nail plug or by eccentric rotation to pack a nail sleeve to secure the screw in place. However, a hole at the location to be fastened with the screw on the furniture, usually made of wood planks, is drilled first, and the nail plug is forced into the drilled hole before forthwith mounting the screw into the nail plug so as to secure other component, e.g., a hinge or a slide, to the furniture when the furniture is assembled in the use of a nail plug and screw.

However, the fastening means of the prior art does not provide convenient operation on site installation of the furniture within a limited space. Longer time must be consumed for the site operation and that means more expenses the user has to pay.

### SUMMARY OF THE INVENTION

The primary purpose of the present invention is to provide a fast nail plug by inserting an inner sleeve into an outer sleeve to provide fast and easy site operation and allow installation options so as to correct the problems of inconvenient site operation while longer time and higher costs of site operation are required as found with the prior art.

To achieve the purpose, a fast nail plug of the present invention comprises an outer sleeve and an inner sleeve. The outer sleeve is a cylinder having a through hole and comprises axial slots extending from one end of the outer sleeve towards the middle section of the outer sleeve so as to provide flexibility to the outer sleeve. A number of ribs are externally disposed on the outer sleeve. The inner sleeve is a cylinder having a through hole and comprises a first end and a second end opposite to each other. The first end of the inner sleeve is disposed with a locking wall, and the second end of the inner sleeve is disposed with a retaining wall. The outer diameter of each of the locking wall and the retaining wall is larger than the inner diameter of the through hole of the outer sleeve. The locking wall is flexible by extending from the first end axial slots towards its middle section of the inner sleeve, and a beveled guide surface is provided on the locking wall to penetrate into the through hole of the outer sleeve and to lock up the outer sleeve by means of the locking wall and the retaining wall.

Preferably each of the ribs externally disposed on the outer sleeve is a rib ring indicating a shape of inverse hook.

Preferably a retainer is provided in the through hole of the outer sleeve and a corresponding protrusion is externally provided on the inner sleeve.

Accordingly, the present invention provides the following advantages and improvements:

1. It allows easy mounting and dismounting;

2. Option of fast mounting and dismounting is possible to realize short time for site operation, and reduced operation costs; and

3. It allows fast mounting and dismounting or permanent fastening of furniture hardware and wood planks including roller slide, steel ball slide, and closet door panel hinge.

### BRIEF DESCRIPTION OF THE DRAWINGS

FIG. 1 is an exploded view of a preferred embodiment of the present invention.

FIG. 2 is an exploded view showing that the preferred embodiment of the present invention is applied on a roller slider.

FIG. 3 is a schematic view showing that the preferred embodiment is applied in the assembly of the roller slide with an inner sleeve and the roller slide to be locked up first.

FIG. 4 is a sectional view showing that the preferred embodiment is applied in the assembly of the roller slide.

FIG. 5 is a schematic view showing that the preferred embodiment is applied in the removal of the roller slide while the inner sleeve remains secured in the roller slide after fast removal.

FIG. 6 is an exploded view showing another preferred embodiment of the present invention.

FIG. 7 is a cross-sectional view showing that the assembly of another preferred embodiment of the present invention when a retainer of the outer sleeve holds against a protrusion of the inner sleeve.

FIG. 8 is a schematic view showing that another preferred embodiment is applied in the removal of the roller slide while the inner sleeve remains secured in the outer sleeve after a fastener is removed.

FIG. 9 is an exploded view showing that the preferred embodiment of the present invention is applied in a steel ball slide.

FIG. 10 is an exploded view showing that the preferred embodiment of the present invention is applied in mounting a hinge to a closet door panel.

### DETAILED DESCRIPTION OF THE PREFERRED EMBODIMENTS

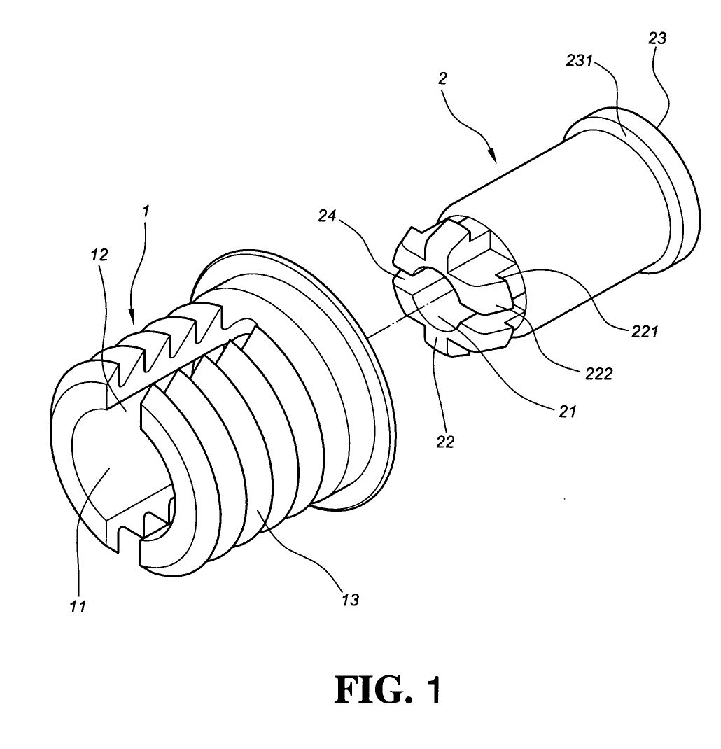

Referring to FIG. 1, a preferred embodiment of the present invention includes an outer sleeve (1) and an inner sleeve (2). The outer sleeve (1) is a cylinder having a through hole (11) and comprises axial slots (12) extending from one end of the outer sleeve (1) towards its middle section to provide flexibility to the outer sleeve (1) and a plurality of ribs (13) externally disposed on the outer sleeve (1). Each rib (13) is a rib ring in shape of inverse hook.

The inner sleeve (2) is a cylinder having a through hole (21), and comprises a first end (22) and a second end (23) opposite to each other. The first end (22) is provided with a locking wall (221), and the second end (23) is provided with a retaining wall (231). The outer diameter of each of the locking wall (221) and the retaining wall (231) is larger than the inner diameter of the through hole (11) of the outer sleeve (1). The locking wall (22) is made flexible by having extending from the first end (22) axial slots (24) towards the middle section of the outer sleeve (2). A beveled guide surface (221) is disposed on the locking wall (221) to penetrate into the through hole (11) of the outer sleeve (1) and lock up the outer sleeve (1) by means of the locking wall (221) and the retaining wall (231).

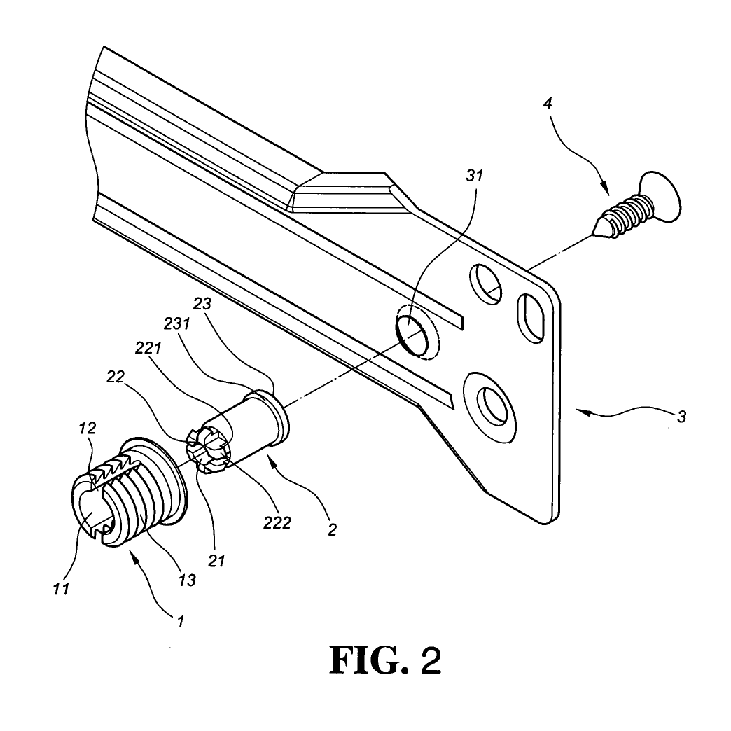

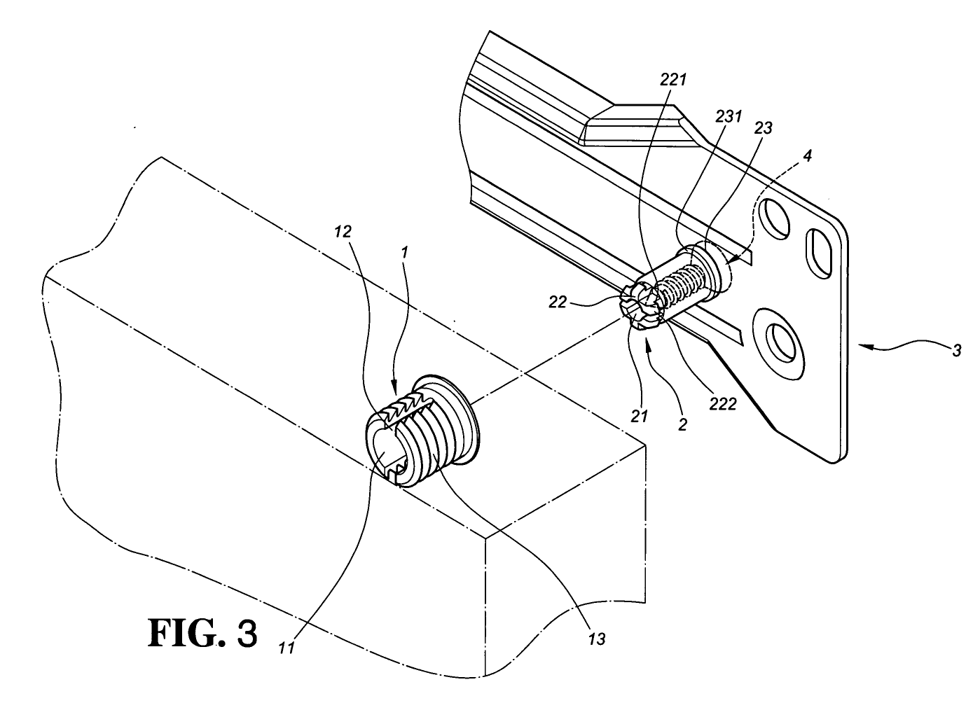

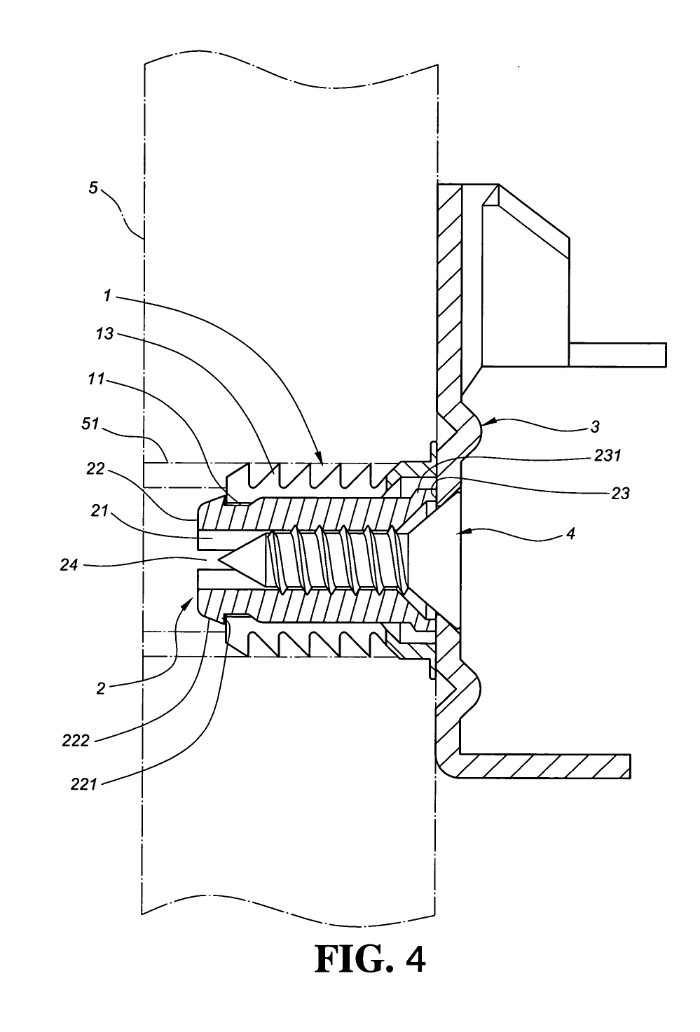

Now referring to FIGS. 2, 3, and 4 respectively showing the application of the present invention in a roller slide (3), a small, low load drawer slide in this preferred embodiment, a fastener (4) in the form of a screw is used. In practice, a hole (51) is drilled first at a location (5) where to be fastened on the work object, a piece of furniture in this preferred embodiment. As illustrated in FIG. 3, a general furniture hardware supplier may place the inner sleeve (2) in a hole (31) drilled on the roller slide (3) and the fastener (4) penetrates through the hole (31) to be fastened to the inner sleeve (2). When attaching the roller slide (3) to the furniture, it takes simply to insert the outer sleeve (1) into the hole (51) and the inner sleeve (2) with its beveled guide surface (222) to penetrate into the through hole (11) of the outer sleeve (1) for the inner sleeve (2) to hold tightly again the outer sleeve (1). Meanwhile, the locking wall (221) at the first end (22) of the inner sleeve (2) holds against the outer edge of the outer sleeve (1) as illustrated in FIG. 4 so to secure the roller slide (3) to the pre-designated location (5).

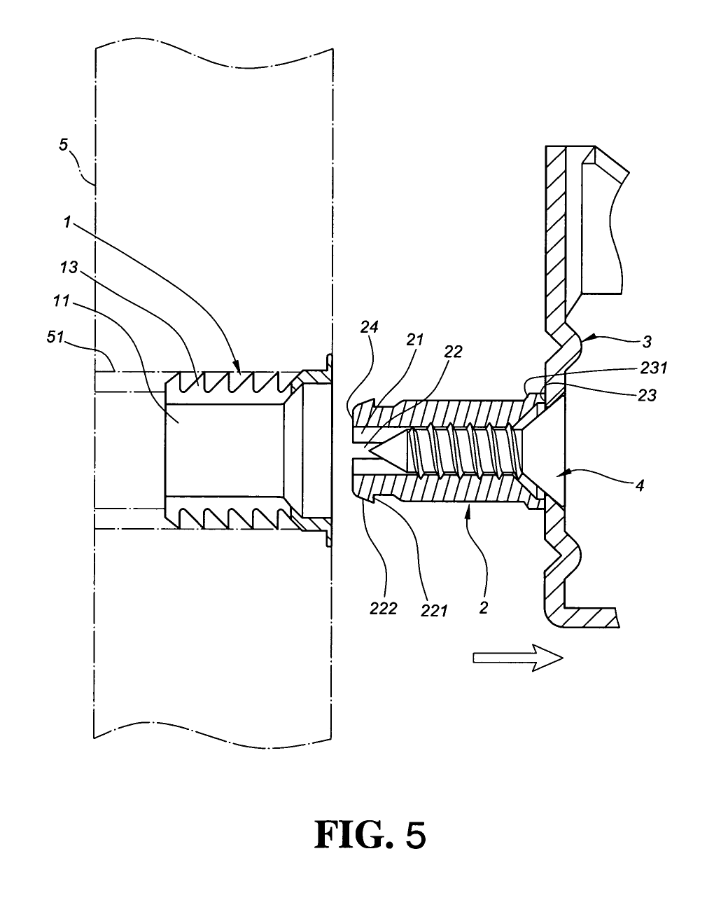

When removing the nail plug as illustrated in FIG. 5, the roller slide (3) and the inner sleeve (2) are directly removed together with the fastener (4) to achieve fast removal.

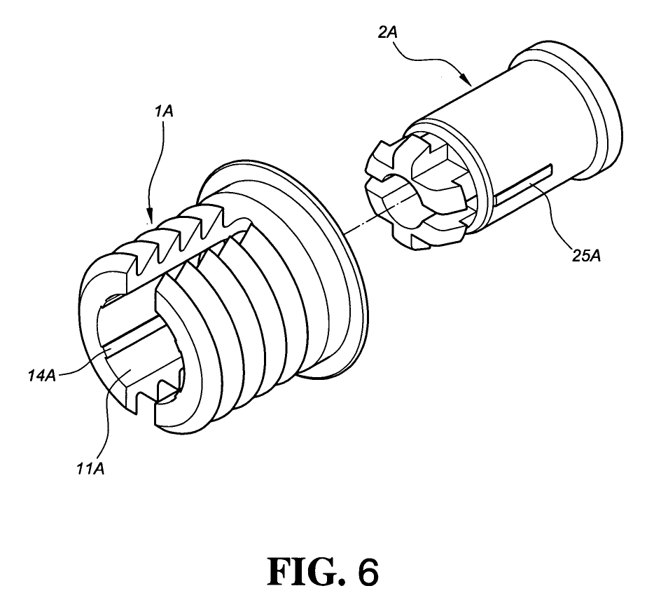

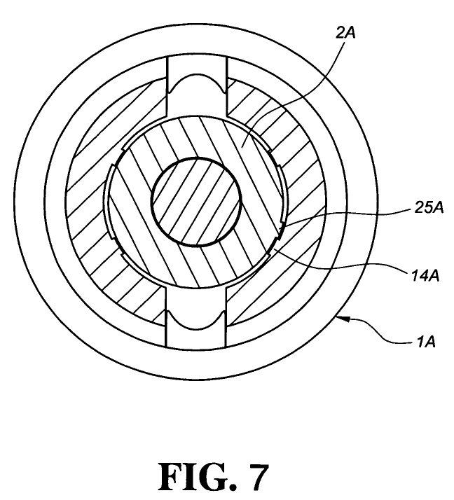

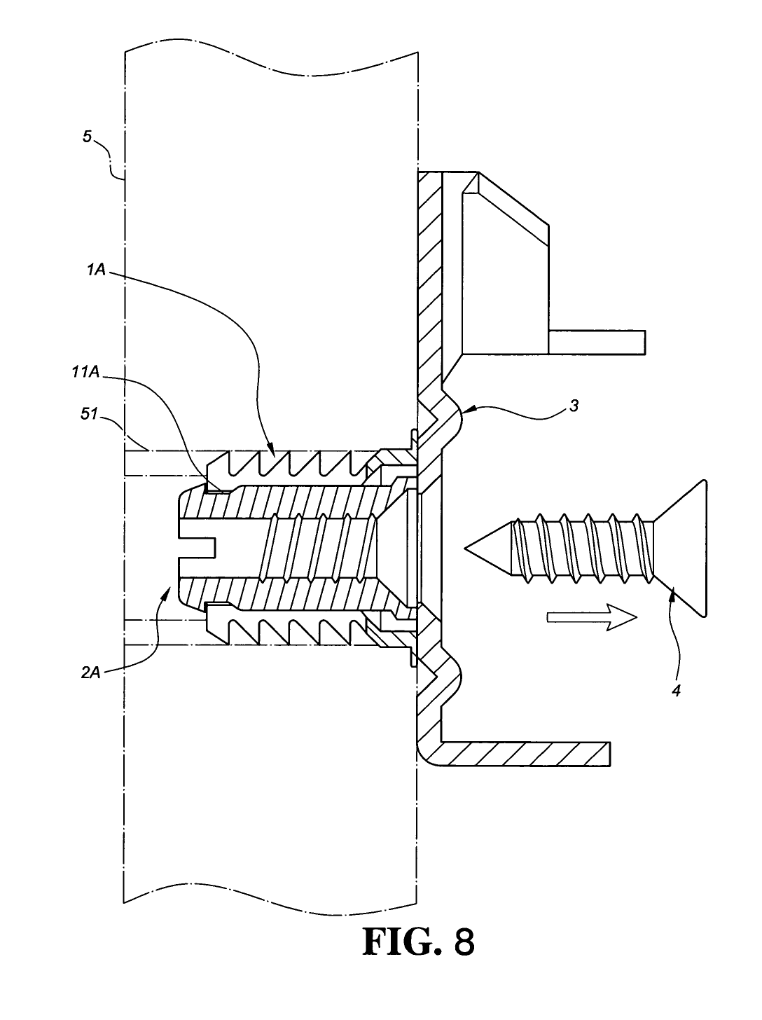

Now referring to FIG. 6 for another preferred embodiment of the present invention, an axial protrusion (25A) is externally disposed on an inner sleeve (2A), at least one axial retainer (14A) is disposed in a through hole (11A) of an outer sleeve (1A). Accordingly, when the fastener (4) is engaged to the inner sleeve (2A) and the inner sleeve (2A) is locked into the through hole (11A) of the outer sleeve (1) as illustrated in FIG. 7, the protrusion (25A) of the inner sleeve (2A) holds against the retainer (14A), thus the inner sleeve (2A) refrains from being driven to rotate by the fastener (4). Therefore, when removing the nail plug as illustrated in FIG. 8, the fastener (4) can be forthwith dismounted before removing the roller slide (3) to leave the inner sleeve (2A) in the outer sleeve (1A). Later, when required, the roller slide (3) may be locked up to the assembly of the inner sleeve (2A) and the outer sleeve (1A) by means of the fastener (4). The present invention provides two options of the operation fashion for the user to select.

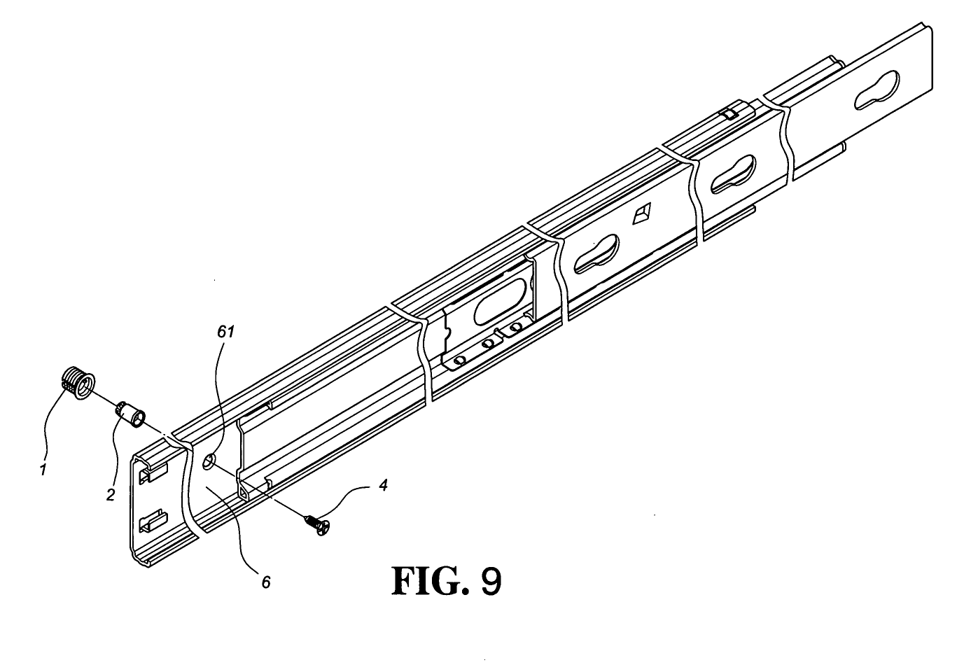

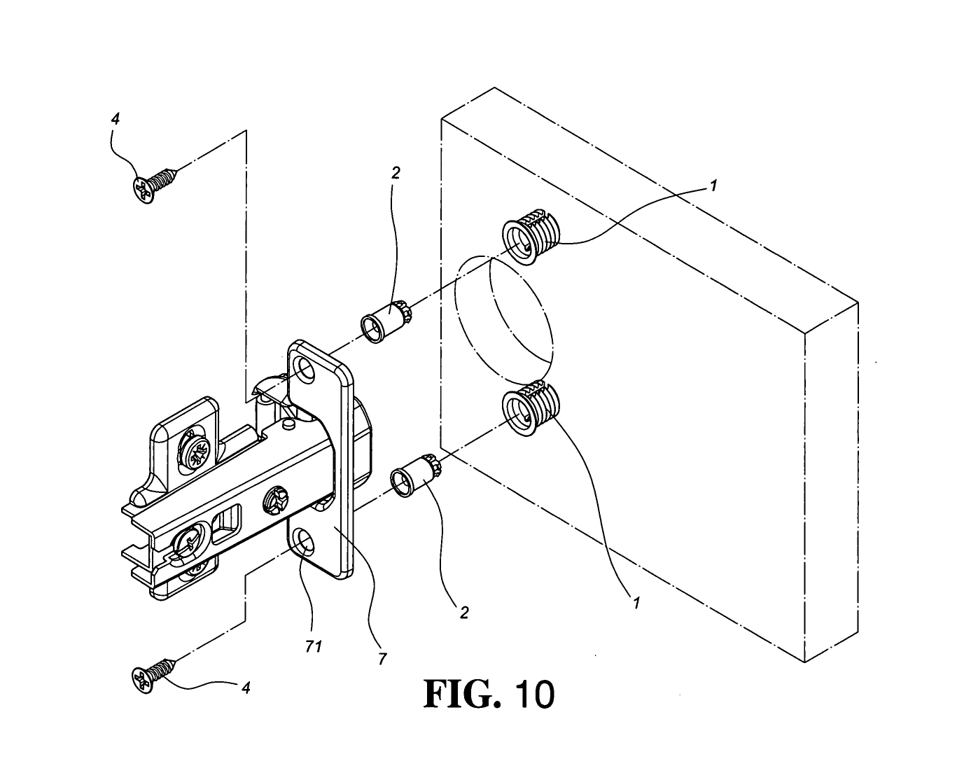

As illustrated in FIGS. 9 and 10, either preferred embodiment of the present invention is respectively applied in a steel ball slide (6) and in a hinge (7) mounted to a door panel of a closet, the present invention is not only applicable to fast mounting or dismounting for the roller slide (3) (a small, low load drawer slide as generally available in the market), but also to the steel ball slide (6) (heavier load of a closet drawer or a computer cable rack), and the hinge (7) on the closet door panel (as usually found with a piece of furniture) or any other panel of similar furniture. In the case of the steel ball slide (6), the fastener (4) penetrates a hole (61) drilled on the steel ball slide (6) to be engaged in the inner sleeve (2) while the inner sleeve (2) is locked in the through hole (11) of the outer sleeve (1) so as to secure the steel ball slide (6); or in the case of the hinge (7) mounted to a closet door panel, the fastener (4) penetrates a hole (71) drilled on the hinge (7) to be engaged in the inner sleeve (2) and the inner sleeve (2) is secured in the through hole (11) of the outer sleeve (1) to secure the hinge (7) to the door panel of the closet.

What is claimed is:

1. A fast nail plug, comprising:
an outer sleeve, being a cylinder having a through hole and comprising axial slots extending from one end of the outer sleeve towards a middle section of the outer sleeve to provide flexibility and a plurality of ribs externally disposed on the outer sleeve; and
an inner sleeve, being a cylinder having a through hole and comprising a first end and a second end, the first end being provided with a locking wall, the second end being provided with a retaining wall; each of the locking wall and the retaining wall having an outer diameter that is larger than an inner diameter of the through hole of the outer sleeve, the locking wall being made flexible by providing axial slots extending from the first end towards a middle section of the inner sleeve; the locking wall being provided with a beveled guide surface to penetrate into the through hole of the outer sleeve, and the inner sleeve being locked up the outer sleeve by means of the locking wall and the retaining wall.

2. The fast nail plug as claimed in claim 1, wherein each of the ribs externally disposed on the outer sleeve is a rib ring in shape of an inverse hook.

3. The fast nail plug as claimed in claim 1, wherein a retainer is disposed inside the outer sleeve and a corresponding protrusion is externally disposed on the inner sleeve.
